(19) United States
(12) Patent Application Publication
(10) Pub. No.: US 2016/0349593 A1
(43) Pub. Date: Dec. 1, 2016

(54) CHARGE CONTROL AGENT FOR ELECTROPHORETIC DISPLAY

(71) Applicant: E INK CALIFORNIA, LLC, Fremont, CA (US)

(72) Inventors: Hui DU, Milpitas, CA (US); Joshua A. RITCHEY, Melrose, MA (US); Olga V. BARYKINA-TASSA, Boston, MA (US); Vladimir SOFIYEV, Oakland, CA (US)

(21) Appl. No.: 15/162,838

(22) Filed: May 24, 2016

Related U.S. Application Data
(60) Provisional application No. 62/167,801, filed on May 28, 2015.

(51) Int. Cl. G02F 1/167; C08F 10/10

(52) U.S. Cl. CPC G02F 1/167; C08F 10/10; G02F 2001/1678

(57) ABSTRACT

The present invention is directed to a group of charge control agents suitable for use in an electrophoretic display. The charge control agent can improve the optical performance of an electrophoretic display.

This application claims priority to U.S. Provisional Application No. 62/167,801, filed May 28, 2015; the contents of which is incorporated herein by reference in its entirety.

### FIELD OF THE INVENTION

The present invention is directed to a group of charge control agents suitable for use in an electrophoretic display.

### BACKGROUND OF THE INVENTION

An electrophoretic display (EPD) is a non-emissive device based on the electrophoresis phenomenon influencing charged pigment particles dispersed in a dielectric solvent. An EPD typically comprises a pair of spaced-apart plate-like electrodes. At least one of the electrode plates, typically on the viewing side, is transparent. An electrophoretic fluid composed of a dielectric solvent with charged pigment particles dispersed therein is enclosed between the two electrode plates.

An electrophoretic fluid may have one type of charged pigment particles dispersed in a solvent or solvent mixture of a contrasting color. In this case, when a voltage difference is imposed between the two electrode plates, the pigment particles migrate by attraction to the plate of polarity opposite that of the pigment particles. Thus, the color showing at the transparent plate can be either the color of the solvent or the color of the pigment particles. Reversal of plate polarity will cause the particles to migrate back to the opposite plate, thereby reversing the color.

Alternatively, an electrophoretic fluid may have two types of pigment particles of contrasting colors and carrying opposite charges and the two types of pigment particles are dispersed in a clear solvent or solvent mixture. In this case, when a voltage difference is imposed between the two electrode plates, the two types of pigment particles would move to opposite ends. Thus one of the colors of the two types of pigment particles would be seen at the viewing side.

An electrophoretic fluid may also comprise multiple types of charged pigment particles of different optical characteristics. The different types of charged pigment particles have different charge polarities and/or charge levels. Such a fluid may allow a display device to display multiple color states.

The charge behavior of each type of pigment particles depends on both the particle surface chemistry and the presence of charge control agent(s) in the fluid.

The charge control agent in fact plays a critical role in controlling the optical performance of a display device.

### BRIEF DESCRIPTION OF THE DRAWINGS

FIGS. 1A and 1B are two examples illustrating the term “voltage insensitive range”.

FIG. 2 shows the effect of a charge control agent of the present invention on the voltage insensitive range.

### DETAILED DESCRIPTION OF THE INVENTION

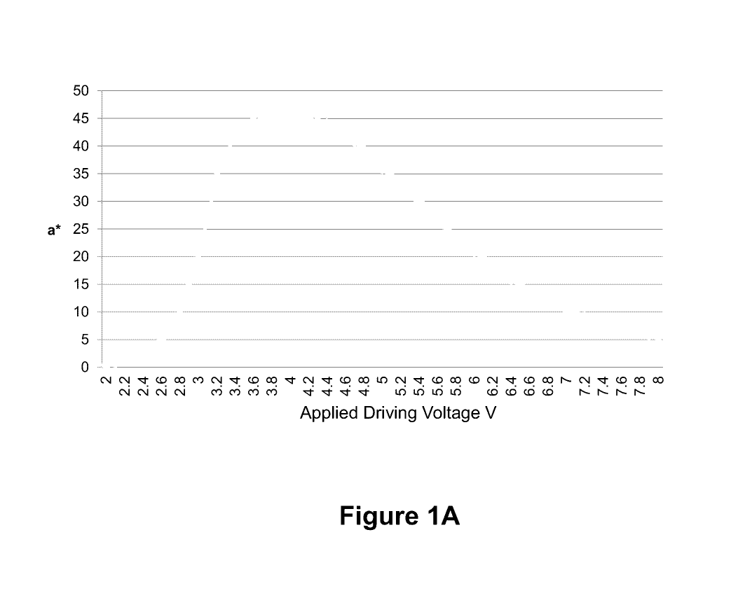

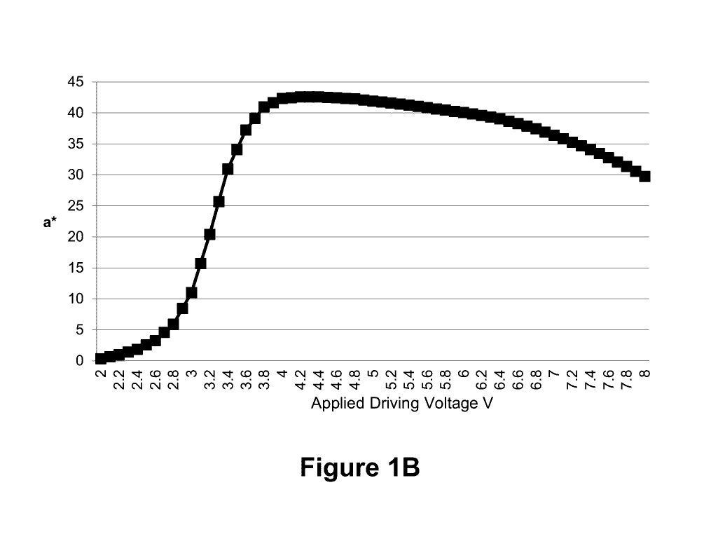

FIG. 1A shows the relationship between applied driving voltage (V) and the optical performance of a display device. The optical performance is expressed in the a* value, utilizing the L*a*b* color system. At a red color state, a higher a* value is indicative of higher color quality.

The maximum a* in FIG. 1A appears at the applied driving voltage V being about 3.8V. However, if a change of ±0.5V is made to the applied driving voltage, the resulting a* value would be about 37 which is roughly 90% of the maximum a*, thus still acceptable. This tolerance can be beneficial to accommodate changing of the driving voltages caused by, for example, variation in the electronic components of a display device, drop of battery voltage over time, batch variation of the TFT backplanes, batch variation of the display devices or temperature and humidity fluctuations.

If any of the driving voltages in a particular range is applied which does not significantly affect the optical performance (i.e., within 90% of the maximum performance) of a display device, such a range is referred to as “voltage-insensitive range”, in the present application.

The wider the “voltage insensitive” range, the more tolerant the optical performance is to batch variations and environmental changes. FIG. 1B demonstrates a wider voltage insensitive range, as in this case, the range [(i.e., 2.8V=(3.7V to 6.5V)] is twice the width of the voltage-insensitive range in FIG. 1A [(i.e., 1.4V=(3.3V to 4.7V)].

The present inventors now have found a group of charge control agents which are particularly useful in increasing the “voltage-insensitive range” of an electrophoretic display, especially for a color electrophoretic display driven at a low voltage.

The charge control agent of the present invention may be generically referred to as polyisobutylene derivative quaternary amine salts, expressed by the following formula (I):

(CH₃)₃C—[—CH₂C(CH₃)₂—]ₙ-L-NR¹R²R³⁺X⁻ (I)

The compound, as shown, has a polyisobutylene derivative moiety with a quaternary amine as an end-functionality. The molecular weight of the compound may be in the range of 300-3000, preferably in the range of 500-2000.

L is a linking chain which may be a saturated or unsaturated alkylene or amide-alkylene chain of 2 to 6 carbon atoms, such as —CRR—CR═CR—CRR, —CRR—CRR—CRR— or —NHC(O)—CRR—CRR—CRR— wherein the R's are independently hydrogen or an alkyl of 1-4 carbon atoms. For example, L may be —CH₂—CH₂—CH₂—, —CH₂—CH═CH—CH₂—, —CH₂—CH₂—CH(CH₃)—, —CH₂—CH(CH₃)—CH₂— or —NHC(O)—CH₂—CH₂—CH₂—.

R¹, R² and R³ are independently an alkyl of 1-4 carbon atoms;

X⁻ is a counter ion. Examples of preferred counter ion include F⁻, Br⁻, R′SO₃⁻, R′SO₄⁻ or R′CO₃⁻, wherein R′ is an alkyl of 1-4 carbon atoms or an aryl of 6 to 18 carbon atoms optionally substituted with an alkyl of 1-4 carbon atoms.

In one embodiment, the counter ion is R′SO₄⁻ wherein R′ is an alkyl of 1-4 carbon atoms, preferably a methyl.

In another embodiment, the counter ion is R′SO₃⁻ wherein R′ is a phenyl optionally substituted with an alkyl of 1-4 carbon atoms, preferably a methyl.

In another embodiment, the counter ion is a halogen, such as F⁻, Cl⁻, Br⁻ or I⁻.

The compound compound of the present invention may be added to an electrophoretic fluid comprising charged pigment particles dispersed in a solvent or solvent mixture. In the following example, the compound of the present invention has demonstrated to be able to not only widen the voltage-insensitive range of a display device, but also improve the optical performance of the display device.

In an electrophoretic fluid, the concentration of the charge control agent of the present invention may be in the range of 0.05%-0.6% by weight, preferably 0.05% to 0.15% by weight.

The synthesis of the compounds is demonstrated in the example below. The procedure may be followed with appropriate reagents to prepare other compounds of the present invention.

### Example

### Part A

Dimethyl sulfate (115 mL, 6.5 eq. based on the active amine, Sigma-Aldrich) was added dropwise over 40 minutes to a mixture of Kerocom PIBA 03 (polyisobutylene amine) (192 g, BASF) and potassium carbonate (85.0 g, 3.3 eq, Acros Organics) in a mixture of methanol and tetrahydrofuran (5:1, 385 mL) under inert atmosphere at 40° C. with vigorous stirring. After 2 hours, the mixture was cooled to room temperature and stirred for an additional 16 hours. The mixture was then concentrated and partitioned between hexane and water. The organic phase was separated, filtered and concentrated yielding 223 g of very viscous colorless or light-yellow oil that was used in Part B below. The identity of the material produced was confirmed to be polyisobutylene quaternary amine sulfate salt (that is, a compound of Formula I wherein L is —CH₂—CH₂—CH(CH₃)—, R¹, R² and R³ are methyl and the counter ion is R′SO₄⁻ wherein R′ is methyl) by NMR.

### Part B

A series of electrophoretic fluids containing four types of charged particles of different colors (black, white, red and yellow) were dispersed in an Isopar® solvent. All the fluids had the same composition, except that each contained a different amount of a charge control agent, polyisobutylene quaternary amine sulfate salt prepared in Part A above.

Each fluid was sandwiched between two electrode plates and driven to different color states at different driving voltages. The a* value of each fluid at a given driving voltage was measured by the i-One instrument and recorded.

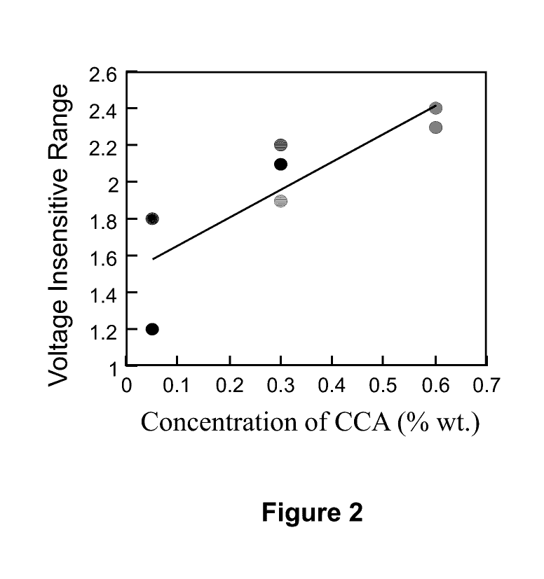

The results are shown in FIG. 2. The Y axis represents the width of the “voltage-insensitive range” and the X axis represents the concentration of the charge control agent (in wt %). As shown, the voltage-insensitive range became wider when the concentration of the charge control agent increased.

### Part C

Two electrophoretic fluids containing four types of charged particles of different colors (black, white, red and yellow) were dispersed in an Isopar® solvent. Both fluids had the same composition, except that Fluid I had the polyisobutylene quaternary amine sulfate salt prepared in Part A above added, and Fluid II did not.

Each fluid was sandwiched between two electrode plates and driven to different color states, which was measured by the i-One instrument and recorded. As shown in the table, Fluid I showed better white (higher WL*) and also better yellow state (higher Yb*) than Fluid II.

| | | Fluid I | Fluid II |
|---|---|---|---|
| White | WL* | 59.2 | 56.6 |
| Yellow | Yb | 41.8 | 31.0 |

While the present invention has been described with reference to the specific embodiments thereof, it should be understood by those skilled in the art that various changes may be made and equivalents may be substituted without departing from the scope of the invention. In addition, many modifications may be made to adapt a particular situation, materials, compositions, processes, process step or steps, to the objective and scope of the present invention. All such modifications are intended to be within the scope of the claims appended hereto.

What is claimed is:

1. A compound of the following formula:
(CH₃)₃C—[—CH₂—C(CH₃)₂—]ₙ-L-NR¹R²R³⁺X⁻
wherein L is a linking chain;
R¹, R² and R³ are independently an alkyl of 1-4 carbon atoms; and
X⁻ is a counter ion.

2. The compound of claim 1, wherein L is a saturated or unsaturated alkylene or amide-alkylene chain of 2 to 6 carbon atoms

3. The compound of claim 2, wherein L is —CRR—CR═CR—CRR—, —CRR—CRR—CRR— or —NHC(O)—CRR—CRR—CRR— wherein the R's are independently hydrogen or an alkyl of 1-4 carbon atoms.

4. The compound of claim 3, wherein L is —CH₂—CH₂—CH₂—, —CH₂—CH═CH—CH₂—, —CH₂—CH₂—CH(CH₃)—, —CH₂—CH(CH₃)—CH₂— or —NHC(O)—CH₂—CH₂—CH₂—.

5. The compound of claim 4, wherein L is —CH₂—CH₂—CH(CH₃)—.

6. The compound of claim 1, wherein R¹, R² and R³ are methyl.

7. The compound of claim 1, wherein X⁻ is F⁻, Cl⁻, Br⁻, R′SO₃⁻, R′SO₄⁻ or R′CO₃⁻, wherein R′ is an alkyl of 1-4 carbon atoms or an aryl of 6 to 18 carbon atoms optionally substituted with an alkyl of 1-4 carbon atoms.

8. The compound of claim 7, wherein X⁻ is R′SO₄⁻ wherein R′ is an alkyl of 1-4 carbon atoms.

9. The compound of claim 8, wherein R′ is methyl.

10. The compound of claim 1, wherein X⁻is R′SO₃⁻ wherein R′ is a phenyl optionally substituted with an alkyl of 1-4 carbon atoms.

11. An electrophoretic fluid comprising charged pigment particles and a compound of claim 1 in a solvent or solvent mixture.

12. The fluid of claim 11, wherein the compound of claim 1 has L being —CH₂—CH₂CH(CH₃)—, R¹, R² and R³ being methyl and the counter ion being R′SO₄⁻ wherein R′ is methyl.

13. The fluid of claim 11, wherein the concentration of the compound of claim 1 is in the range of 0.05% to 0.6% by weight.
